(19) United States
(12) Patent Application Publication
(10) Pub. No.: US 2023/0330680 A1
(43) Pub. Date: Oct. 19, 2023

(54) PORTABLE ELECTROPHORESIS SYSTEM WITH INTEGRATED THERMOCYCLER

(71) Applicant: BIOPTIC, INC., New Taipei City (TW)

(72) Inventors: Shou-Kuan TSAI, New Taipei City (TW); Hsien-Liang CHI, New Taipei City (TW); Varouj D. AMIRKHANIAN, La Canada Flintridge, CA (US)

(21) Appl. No.: 18/182,316

(22) Filed: Mar. 10, 2023

Related U.S. Application Data
(60) Provisional application No. 63/318,778, filed on Mar. 10, 2022.

(51) Int. Cl. B01L 7/00

(52) U.S. Cl. CPC B01L 7/52

(57) ABSTRACT

A thermal control module for a bioseparation system, comprising: a thermal platform thermally coupled to the thermoelectric module, wherein the thermal platform comprises: a base, and at least a thermal block thermal conductively supported on the base, wherein the thermal block is structured to receive a receptacle containing at least a sample, and wherein the thermal block comprises a body comprising a split longitudinal block having two longitudinal sides defining a valley, wherein the facing walls of the sides each has a scalloped concave profile conforming to convex conical tube shaped profile of bottom surfaces of the wells of the receptacle tray; a heat sink; and a thermoelectric module thermal conductively coupled between the base of the thermal platform and the heat sink, heating/cooling the thermal platform in accordance with desired heating/cooling temperature profile.

### PRIORITY CLAIM

This application claims the priority of U.S. Provisional Patent Application No. 63/318,778 filed on Mar. 10, 2022. This application and all published documents discussed below are fully incorporated by reference as if fully set forth herein.

### BACKGROUND OF THE INVENTION

### 1. Field of the Invention

The present invention relates to bio-analysis, in particular a capillary electrophoresis instrument that includes sample processing, more specifically a capillary electrophoresis instrument that includes thermal control module (e.g., heating, cooling, thermocycling) for sample processing (e.g., PCR: Polymerase Chain Reaction).

### 2. Description of Related Art

Capillary electrophoresis (CE) separation is a micro fluidic approach to gel-electrophoresis (micro-channel device to simplify gel-electrophoresis separation), whose greatest advantage is its diverse range of applications. CE technology is commonly accepted by the biotechnology industry specifically in the nucleic acid-based testing as a reliable, high resolution and highly sensitive separation and detection tool, and CE has been applied for, e.g., protein, carbohydrate and DNA-related analyses such as oligonucleotides analysis, DNA sequencing, and dsDNA fragments analysis, and glycan profiling.

U.S. Pat. No. 8,778,155, commonly assigned to the assignee of the present invention, discloses a reusable cartridge-based portable electrophoresis system configured to utilize a pen shaped bio-separation cartridge that is easy to assemble and use with no moving parts and that has an integrated reagent (separation buffer) reservoir. The cartridge includes a body, defining an opening as a detection window for receiving external detection optics, at least one capillary column supported in the body, having a first end extending beyond a first end of the body, wherein the detection window exposes a section along the capillary column, to which the external optics are aligned through the detection window, and a reservoir attached to a second end of the body in fluid flow communication with a second end of the capillary column. The reservoir is structured to be coupled to an air pressure pump or N2 tank that pressurizes the gel reservoir to purge and fill the capillaries with buffer/gel as the separation support medium. A negatively charged sample can be loaded into the capillary column to perform CE separation for analyses. At the conclusion of the sample separation run, the spent sample (negatively charged separated DNA/RNA fragments) are trapped in the gel-reservoir (large pool) within the embedded electrode (Anode) away from the output of the capillary column. Another sample may be subsequently loaded into the capillary column and analyzed in another run using the same cartridge.

In connection with DNA/RNA analyses based on CE separations, polymerase chain reaction (abbreviated PCR) is a laboratory technique for rapidly producing (amplifying) millions to billions of copies of a specific segment of DNA, which can then be studied in greater detail at high resolution without requiring a large sample volume of DNA/RNA to be initially provided. PCR involves using short synthetic DNA/RNA fragments called primers to select a segment of the genome to be amplified, and then multiple rounds of DNA/RNA synthesis to amplify that segment prior to traditional gel-electrophoresis or capillary electrophoresis (CE) separation and detection analysis, thus providing high resolution results based on an initial low sample volume intake (e.g., in picoliters). The PCR process requires thermocycling of the sample DNA segment to prepare the sample for subsequent CE separation analysis.

Heretofore, it has been a longstanding practice to adopt a separate PCR process undertaken with a thermocycler that is not part of (i.e., outside) the CE separation and detection system/instrument, and the prepared sample is then transferred to the CE system for separation analysis. U.S. Pat. No. 11,531,004, commonly assigned to the assignee of the present invention, discloses a CE instrument that includes a temperature control mechanism, such as a Peltier heating/cooling module interfaced with (e.g., below) the a table that supports sample vials to be positioned below a capillary cartridge. The heating/cooling module provides temperature control to facilitate PCR amplification and electrophoresis/detection in one instrument.

There is a need for an improved CE system that includes an improved thermocycler within the system.

### SUMMARY OF THE INVENTION

We introduce a portable capillary gel electrophoresis system with an integrated thermal cycler to perform Polymerase Chain Reaction (PCR) for highly efficient, high speed biomolecules analysis applications in molecular diagnosis. The automated PCR-CE system is a newly developed product that will significantly increase the pace at which DNA/RNA research and point-of-care is performed in the labs, saving hours of preparation time and assuring accurate, consistent and economical results.

In one aspect of the present invention, a high-performance capillary gel electrophoresis analyzer system has been integrated with a built-in PCR machine for molecular diagnostics (MDx) applications. The system uses integrated dual fiber optic fluorescence detection technology and a novel disposable pen-shaped gel-cartridge design. The system can hold a total of 8 samples, which can be automatically analyzed within 1-2 hours. The fully automated CE-PCR system uses fluorescence detector (high detection sensitivity) that can be used in laboratories for DNA/RNA amplification and end-point PCR analysis for high-speed molecular diagnostic applications.

The PCR reactors and capillary electrophoresis (CE) have been successfully coupled to form an integrated DNA-fragment analysis system. This construct combines the rapid thermal cycling capabilities of mini-PCR device (open system; no lid/door providing access to sample pickup by gel-cartridge of CE system) with the high-speed DNA separations and fluorescence detection of a CE system. Electrophoretic injection directly from the PCR (open system) chamber through the gel-cartridge is achieved with this system for rapid analysis of biomolecules. To demonstrate the functionality of this system, a 60 min PCR amplification of saliva samples was immediately followed by high-speed CE separation in under 120 s, providing a rapid PCR-CE analysis in under 90 min. A rapid assay for SARS-CoV-2 detection was performed in under 90 min, demonstrating that challenging amplifications of diagnostically interesting targets can also be performed at high detection sensitivity. Real-time monitoring of PCR target amplification in these integrated PCR-CE devices is also feasible due to open system (no lid/door over the PCR module provides easy access to the sample during or after the thermocycling process). The PCR-CE system establishes the feasibility of performing high-speed DNA analyses in an integrated PCR-CE system.

In one aspect of the present invention, a thermal control module for a bioseparation system, comprising: a thermal platform thermally coupled to the thermoelectric module, wherein the thermal platform comprises: a base, and at least a thermal block thermal conductively supported on the base, wherein the thermal block is structured to receive a receptacle containing at least a sample, and wherein the thermal block comprises a body comprising a split longitudinal block having two longitudinal sides defining a valley, wherein the facing walls of the sides each has a scalloped concave profile conforming to convex conical tube shaped profile of bottom surfaces of the wells of the receptacle tray; a heat sink; and a thermoelectric module thermal conductively coupled between the base of the thermal platform and the heat sink, heating/cooling the thermal platform in accordance with desired heating/cooling temperature profile.

In one embodiment, the facing walls are spaced apart by a tapered gap to define the valley to accommodate a joined mid-line sections of wells, and wherein the scalloped profile of the facing walls, along with the gap between the facing walls, substantially conform to the profile of the exterior bottom surfaces of the wells of the receptacle tray, so as to allow efficient thermal conduction between the thermal block and the walls of the wells, to thereby efficiently heat/cool the contents in the wells. In another embodiment, when viewed from the top of the thermal block into the valley, the scalloped profile generally resembles a series of adjoining concave surfaces each having a sectional profile of concave curve or arc (e.g., semicircular or partial thereof) along the facing walls of the thermal block. In a further embodiment, the facing walls of the thermal block define a row of cavities wherein adjacent cavities are joined/connected to accommodate the adjoining mid-line sections at the bottom of the receptacle tray. In still a further embodiment, the adjoining cavities resembles a row of adjoining conical spaces along the tapered gap narrowing/tapering to narrow the gap towards the bottom of the block) for receiving the conical exterior bottom surfaces of the wells in the receptacle tray.

The thermal block receives the body of the receptacle tray with the bottom external walls of the wells in contact with or closely adjacent to the facing walls of the thermal block to facilitate thermal conduction between the sides of the thermal block and the wells.

In one embodiment, the thermal platform comprises two thermal blocks, each thermal conductively supported at a different section of the base of the thermal platform, wherein the thermoelectric module comprises separate heating/cooling submodules that heat/cool the different sections of the base of the thermal platform in accordance with different heating/cooling temperature profiles thereby heating/cooling the thermal blocks in accordance with the different heating/cooling temperature profiles, and wherein the submodules are subject to separate controls to achieve the different heating/cooling temperature profiles of the corresponding thermal blocks to thereby subject samples in the receptacles to different temperature profiles.

In one embodiment, the thermal block and the base are separate structures thermally conductively coupled together or in an integral, monolithic structure, and wherein the thermoelectric module is thermal conductively sandwiched between the thermal platform above and the heat sink below.

In another embodiment, the thermal platform thermal conductively supported on the base of the thermal platform, comprises a second thermal block that comprises a body having a plurality of cavities for receiving receptacle tubes.

In another aspect of the present invention, a bio-separation system, comprises: a chassis; a cartridge supporting a capillary column for capillary electrophoresis, wherein the cartridge body is supported by the chassis; a thermal control module as in any of the above claims , supporting a receptacle containing at least a sample with respect to an extended end of the capillary column, wherein the thermal control module performs heating/cooling the thermal platform in the thermal control module in accordance with desired heating/cooling temperature profile; a separation mechanism effecting bio-separation within the capillary column after loading the sample that was subject to heating/cooling from the receptacle tray; and a controller controlling the separation mechanism to effect separation.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIGS. 1A to 1C are respectively external perspective, sectional and sectional perspective views of a PCR-CE system/instrument incorporating the inventive thermal (heating and cooling) control module, in accordance with one embodiment of the present invention.

FIGS. 2A to 2C are respectively perspective, partial perspective and sectional views of the thermocycling module, in accordance with one embodiment of the present invention.

FIGS. 3A to 3C are perspective views, FIG. 3D is a top view, and FIG. 3E and 3F are sectional perspective views, of a thermal control module including a thermal platform having a thermal block for supporting a receptacle for temperature control (i.e., heating and/or cooling operations), in accordance with one embodiment of the present invention.

FIG. 4A is a top perspective view, FIG. 4B is a bottom perspective view, FIGS. 4C and 4D are sectional perspective views, and FIG. 4E is a bottom view, of a receptacle tray that can be received and supported in the thermal block for temperature control, in accordance with one embodiment of the present invention.

FIGS. 5A to 5C are various perspective views of the receptacle tray supported on the thermal block.

FIG. 6 is a schematic diagram of a simplified PCR-CE workflow using the inventive CE system, in accordance with one embodiment of the present invention.

FIG. 7 is a schematic diagram of a PCR-CE workflow for buccal specimens using the inventive CE system, in accordance with one embodiment of the present invention.

FIG. 8 is a block diagram of the steps for introducing samples into the CE instrument, prepare samples by heating and proceed to RT-PCR and end-point PCR through CE analysis.

FIG. 9 is a schematic diagram of a buccal sample collection procedure, in accordance with one embodiment of the present invention.

FIG. 10 is a schematic diagram of a sample preparation process for buccal sample, in accordance with one embodiment of the present invention.

FIG. 11A is a perspective view a thermal platform and FIG. 11B is a sectional perspective view of a preheat thermal block in accordance with another embodiment of the present invention; FIG. 11C is a perspective view of the thermal platform supporting receptacle tubes on the preheat thermal block and a receptacle tray on the PCR thermal block, in accordance with another embodiment of the present invention.

FIG. 12 is a perspective view of a thermal platform, in accordance with a further embodiment of the present invention.

FIG. 13 is a schematic view of a CE system incorporating the inventive thermal control module, in accordance with one embodiment of the present invention.

### DETAILED DESCRIPTION OF THE PREFERRED EMBODIMENTS

This invention is described below in reference to various embodiments with reference to the figures. While this invention is described in terms of the best mode for achieving this invention's objectives, it will be appreciated by those skilled in the art that variations may be accomplished in view of these teachings without deviating from the spirit or scope of the invention.

References are made to the bioanalytical system including detection system disclosed in U.S. Pat. Nos. 8,778,155, 8,784,626, and 11,531,004 and U.S. Patent Application Publication No. US20150338347A1, the entirety of which are incorporated by reference as if fully set forth herein. These patents and patent applications are commonly assigned to BiOptic, Inc., the applicant and assignee of the present invention. In particular, these patents disclosed a simplified, low cost, high efficiency, highly sensitive, high throughput bio-separation system (e.g., capillary electrophoresis (CE) system). The bio-separation system includes an instrument that is configured to work with single channel or multi-channel capillary cartridges, and that is provided with a detection configuration that includes optics for application of incident radiation at and detection of output radiation from a detection zone along the separation channel, for the detection of radiation emitted by sample analytes (e.g., radiation induced fluorescence emission), without requiring fine alignment of the optics to the separation column. The instrument is configured to conduct bio-separation in the separation channel(s) of the bio-separation cartridge in an automated manner. The CE system has a less complex optical detection mechanism to reduce costs, which complements simplicity in operation, rapid analysis with high efficiency, sensitivity and throughput. US20150338347A1 further discloses fluorescence detection at two colors. The present invention adopts and modifies these systems to include improvements to the system (namely, an inventive thermal controller for, e.g., PCR) in accordance with the disclosure hereinbelow.

For purpose of illustrating the principles of the present invention and not limitation, the present invention is described by reference to embodiments directed to capillary electrophoresis using a single capillary separation column. Further, the present invention will be described, without limitation, in connection with radiation induced fluorescence detection (e.g., using a laser or LED source for excitation).

### System Overview

Miniaturization and automation of analytical instrumentation has many advantages over conventional labor-intensive techniques (i.e. manual Slab-gel Electrophoresis). These advantages include improved data precision and reproducibility, short analysis times, minimal sample consumption, improved automation and integration of complex workflows.

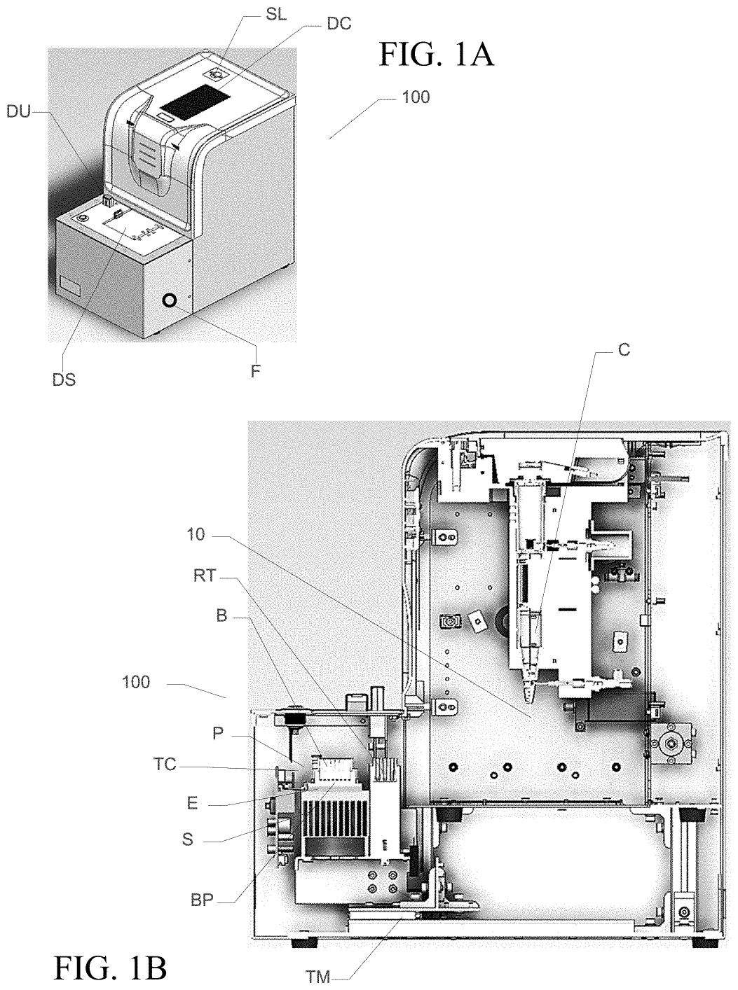

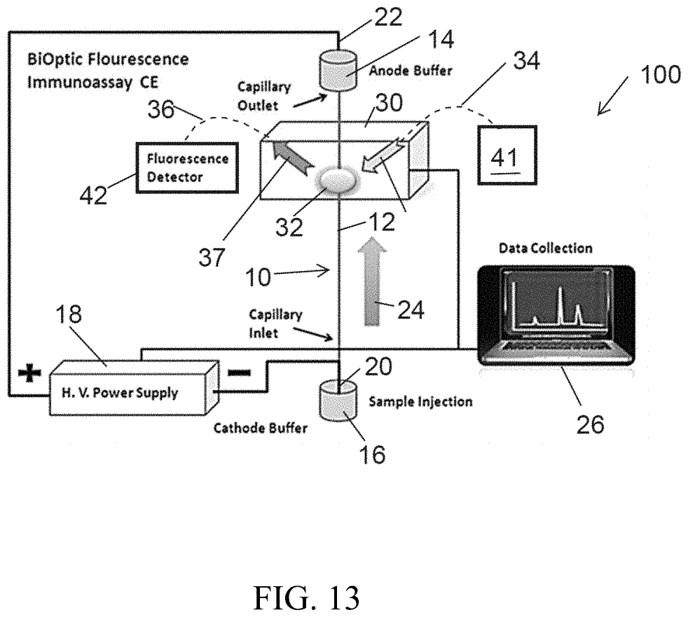

The assignee of the present invention designed a fully automated bio separation instrument/system 100, in particular a CE instrument incorporating a dual stage thermal module for sample preparation and PCR that provides fast amplification, and direct end point PCR check at high-speed separation and fluorescence detection for clinical applications (referred to hereinbelow as a PCR-CE instrument or system). FIGS. 1A to 1C illustrate a PCR-CE system/instrument 100 incorporating the inventive thermal control module, in accordance with one embodiment of the present invention. FIG. 13 is a schematic view of a PCR-CE system incorporating the inventive thermal control module, in accordance with one embodiment of the present invention. The PCR-CE system 100 incorporates the detection configuration as schematically illustrated in FIG. 13. The PCR-CE system 100 generally comprises a capillary separation column 10 (e.g., 200-500 μm O.D.), which defines internal separation channels 12 (e.g., 25-200 μm I.D.), which may be capillary columns 10 (only one separation channel/capillary column is illustrated for simplicity). The capillary column 10 may be made of fused silica, glass, polyimide, or other ceramic/glassy materials. The inside walls of the separation column 10 (i.e., the walls defining the separation channel 12) may be coated with a material that can build up an electrostatic charge to facilitate electrophoresis and/or electrokinetic migration of the sample components. The separation channel 12 may be filled with a separation support medium, which may be simply a running buffer, or a sieving gel matrix (of a linear or non-linear polymeric composition) known in the art.

One end of the capillary column 10 is coupled to a reservoir 14 of running buffer. The other end of the capillary column 10 is coupled to another reservoir 16, which may alternately contain a sample (to be injected into the separation channel 12) and running buffer (after sample injection, to undertake separation). A power supply 18 supplies a high voltage to the reservoirs 14 and 16 via electrodes 20 and 22. In accordance with the illustrated embodiment, the capillary column is supported in a cartridge C disclosed in U.S. Pat. No. 8,778,155, which has been incorporate by reference herein, which is further discussed below.

The mechanism of electrophoresis and radiation induced fluorescence when considered alone are outside the scope of the present invention. For the sake of completeness, it is sufficient to briefly mention the operation of the PCR-CE system 100. In operation, a prepared biological sample, tagged with at least one known fluorophore, is introduced into the far end of the capillary column away from the detection zone, by any of a number of ways that is not part of the present invention (e.g., electrokinetic injection from a sample reservoir or physical pressure injection using a syringe pump). When a DC potential (e.g., 1-30 KV) is applied by the power supply 18 to the electrodes 20 and 22, the sample migrates under the applied electric potential along the separation channel 12 in the direction 24 (e.g., sample that is negatively charged travels toward the positive electrode 22 as shown in FIG. 13) and separates into bands of sample components. The extent of separation and distance moved along the separation channel 12 depends on a number of factors, such as migration mobility of the sample components, the mass and size or length of the sample components, and the separation support medium. The driving forces in the separation channel 12 for the separation of samples could be electrophoretic, pressure, or electro-osmotic flow (EOF) means.

When the sample reaches the detection zone 32, excitation radiation is directed via the excitation fiber 34 in a direction 35 at the detection zone 32. The sample components would fluoresce with intensities proportional to the concentrations of the respective sample components (proportional to the amount of fluorescent tag material). The detector 42 detects the intensities of the emitted fluorescence via the emission fiber 36 in a direction 37, at one or more wavelengths different from that of the incident radiation. The detected emitted radiation may be analyzed by a multi-color (e.g., two-color) detection scheme (further discussed in reference to US20150338347A1 incorporated by reference herein).

For an automated system, a controller 26 (e.g., in the form of an external notebook computer or a desktop computer, or a computing unit integrated on-board the instrument) having a processor, controls the operations of the various components in the PCR-CE system 100 to effect capillary electrophoresis separation and data collection, and controls of other functions discussed herein below. The controller 26 may provide user interface and programming of experiment/test settings and parameters. The controller includes the necessary application software routines, which may also include data reduction applications. The controller 26 may be an integral part of the instrument 100 (e.g., as part of the system board, with application routines coded in ASICs), or it may be a separate unit coupled/interfaced to the PCR-CE instrument 100. FIG. 13 illustrates an embodiment of the PCR-CE instrument 100 with a detached controller 26; FIGS. 1A & 1B illustrate an embodiment of the PCR-CE instrument 100 with an integrated controller 26. The controller 26 and/or the system board may be built into a front panel of the instrument housing. A sample door DS is provided at the front of the housing to allow user access to place and remove a sample and/or receptacle tray R and/or a reagent tray RT. Input/output ports may be provided on the housing, such as a slot SL for reading Secure Digital (SD) cards, a USB port DU, and additional ports for access by an external computing device (e.g., a notebook computer or a mobile device, via USB, Ethernet, Wifi, etc.). The front panel may also include a touch screen user interface panel, which can be used as a control panel for setting operation of the PCR-CE instrument 100.

In the illustrated embodiment in FIG. 13, the controller is external to the housing of the PCR-CE instrument 100, in the form of a desktop computer or notebook computer, which is coupled to the PCR-CE instrument 100 via the system board, e.g., via a USB interface. The external controller 26 may include mass storage devices, display, keyboard, etc., or some of these user interface components may be configured integral to the PCR-CE instrument (e.g., a display and a keyboard on the front housing). Alternatively, the system board may be incorporated as part of the external controller 26, without departing from the scope and spirit of the present invention. The specific implementation of such control is well within the knowledge of one skilled in the art given the disclosure herein.

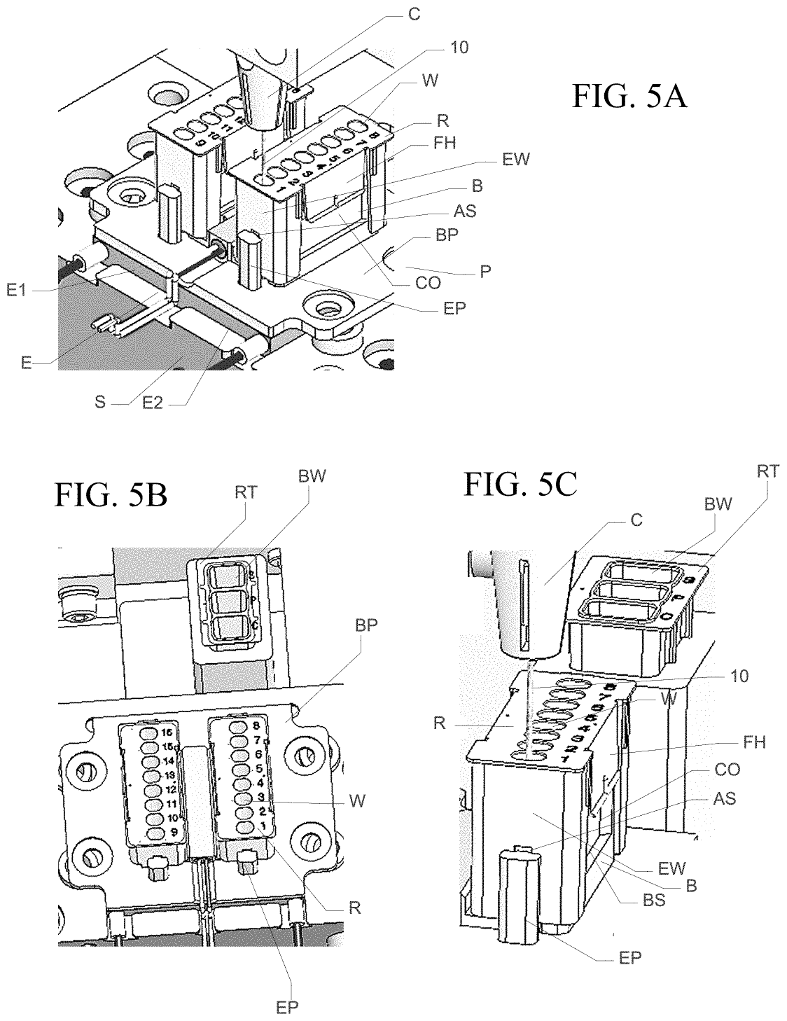

As shown in FIGS. 1B and 1C and FIG. 5C, the cartridge C is vertically supported with the capillary column 10 depending from an end to access the sample wells W in the receptacle tray(s) R supported on the thermal block(s) B and reagents in the well BW in a reagent tray RT carried on a transport mechanism TM (e.g., a transport that moves the various trays in two axis X-Z (horizonal and vertical) or X-Y-Z (horizontal plan and vertical) directions by stepper motors). Further references in this regard may be referenced from the patent publications incorporated by reference herein. A cartridge-door DC is provided at the top side of the instrument housing to allow insertion and removal of the cartridge C. It is noted that the sample wells W in the receptacle tray R correspond to the reservoir 16 shown in the schematic FIG. 13.

A reagent tray RT including buffer wells BW for e.g., buffer solutions is provided for access by the cartridge C.

As an example, using the PCR-CE instrument 100, an entire assay for SARS-CoV-2 detection could be completed in 90 minutes due to the rapid low-volume (1-20 ul) thermal cycling and integrated high-speed electrophoretic separation and detection. The detection limit of this system for multiplex amplification of genomic DNA is as low as 10-20 copies in the PCR-CE system. The preferred technique of disposable gel-cartridge is a simple yet very robust design approach for large volume type manufacturing for an easy to operate capillary gel electrophoresis (CGE) instrument that provides significant background noise reduction, which results in improved signal to noise (S/N) for high detection sensitivity of biomolecules (e.g., pathogens) at very low-cost per sample run.

### Gel-Cartridge C

The reusable single-channel pen-shaped gel-cartridge C permits easy plug-and-play use in a robust injection molded body with integrated gel-reservoir design that incorporates micro-fluidic glass capillary column 10 (e.g., 20-100 μm ID) with an effective separation length of 11cm. The shortened capillary length allows for reduced operating voltages (1-15 KV) and the elimination of expensive cooling systems such or recirculating chillers. The design includes top and bottom electrodes (anode & cathode), an exposed detection zone and an imbedded RFID chip/label to provide ID for the gel-cartridge type and track the number of runs per cartridge. Each cartridge contains linear gel-matrix and is capable of analyzing 100-300 samples in as fast as 2 minutes per sample run, consuming as little as 1 pl directly from the PCR sample wells right after the polymerase chain reaction. The pen-shaped cartridge design with narrow bore capillaries facilitates the sample injection from the PCR sample-wells directly accessible from the integrated thermal cycling module TC, which is an open system that has no lid/door over the wells W of the receptacle tray R supported on the thermal block B. The amplified PCR product is then directly injected into the gel-filled capillary that includes the fluorescent dye (gel-matrix) for electrophoretic analysis. The reusable/disposable gel-cartridge is a simple yet very robust design approach for large volume type manufacturing for an easy to operate CGE instrument that provides significant background noise reduction, which results in improved S/N for high detection sensitivity of biomolecules at very low-cost per sample run.

The pen-shaped gel-cartridge is integrated with a top/outlet buffer/gel reservoir, which is directly coupled to a modular air pressure pump (outside of the instrument). The air pressure pump (or N2 gas tank) provides the required air pressure to fill-up capillary (micro-fluidic channel) with the separation gel/buffer (dynamic coating of capillary). Depending on the viscosity of the separation gel/buffer; pressures of up to 60 PSI is applied to the glass capillary through the top buffer/gel reservoir. Each cartridge reservoir is equipped with built in electrode (Anode), which is automatically connected to the H.V. Power Supply for electrophoresis when installed inside the instrument. The Anode is embedded in the gel reservoir to trap the separated DNA fragments from the large pool of the gel preventing re-injection into the capillary column at the purge stage in between the runs). The test samples (covered with mineral oil) are introduced to the separation capillaries (micro-fluidic channel) by electrokinetic injection directly from PCR sample tray. A high voltage power supply (American Power Design) is used to deliver 0-to-20 KV of electrical field to the capillary for the electrokinetic injection and separations of bio-molecules. Excitation LED with broad band light energy (FWHM=50 nm) and 100 degrees of viewing angle is coupled to large core excite fiber (100-1000 μm) at the flat input end (polished or cleaved end). We use a line filter (FWHM=2-50 nm Band Pass line filter) in front of the LED before coupling the light into the 300 μm Core with 500 μm Ball-ended Excite fiber to reduce background noise. The fluorescence emission signal produced by the separated analytes are then collected at the detection zone of capillary using ball-ended fiber (larger Core fiber with 500 μm Ball) and is relayed down to the Detector Module (using PMT or SiPMT or CCD) with a build in emission filters (Band Pass Filter) for single-color or dual-color type detection.

### PCR-CE Thermal Control Module/Thermocycler TC

The PCR-CE system 100 has an integrated thermal control module TC. For PCR amplification of a DNA/RNA sample, the dual-thermal control module TC is in the form of a thermocycler, which can heat a sample, cool a sample, and/or undertake heating and cooling cycles of the sample. While the discussions hereinbelow refer to a thermocycler TC, it is understood that the thermocycling function thereof is merely the particular control of the thermal control module TC to cycle temperatures, which can also be controlled to raise and/or lower temperatures without cycling between temperatures.

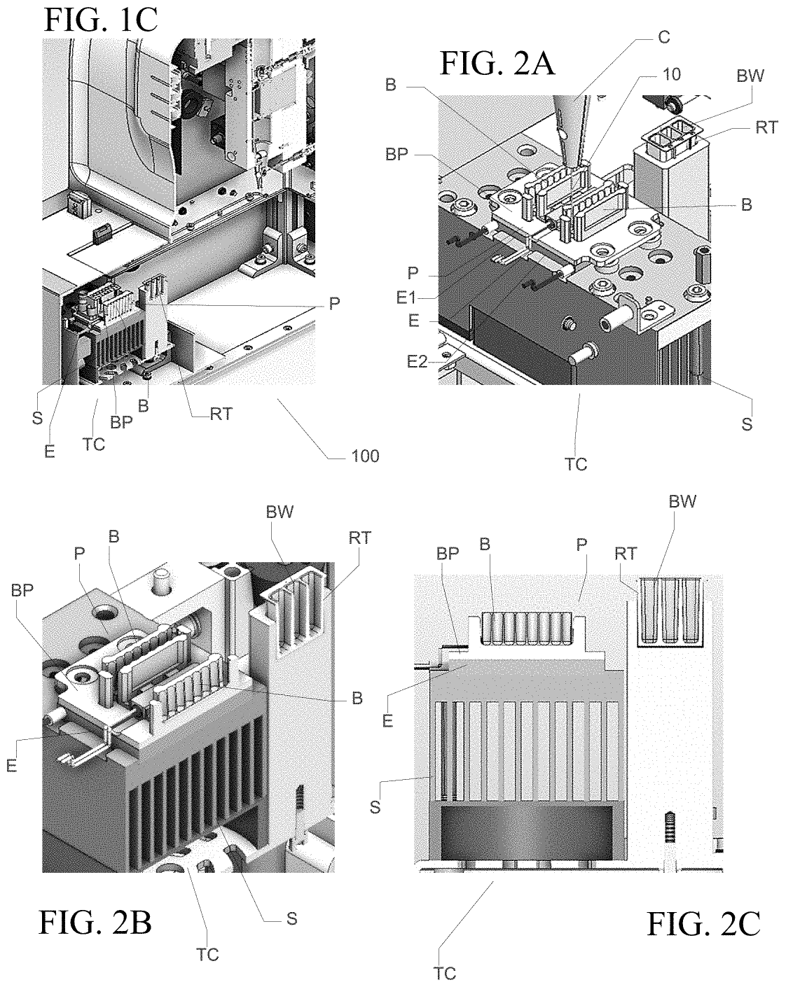

FIGS. 2A to 2C are respectively perspective, partial perspective and sectional views of the thermocycling module, in accordance with one embodiment of the present invention.

The thermocycler TC includes a thermoelectric module E, thermal conductively sandwiched between a heat sink S below and a thermal platform P above. The thermoelectric module E could operate according to Peltier effect, which creates a temperature difference by transferring heat between two electrical junctions when a voltage is applied across the junctions, as well known in the art. The thermoelectric module E thus regulates/controls the temperature of the thermal platform P in accordance with desired heating/cooling temperature profiles, with heat dissipated at the heat sink S. A fan F is provided on the instrument housing to duct air in/out of the housing to ventilate and regulate heat of the heat-sink S in the housing. In the illustrated embodiment (see, also the close-up view in FIG. 5A), the thermoelectric module E has separately controllable submodules E1 and E2 for each half of the thermal platform P, as will be further explained below in connection with the thermal platform P.

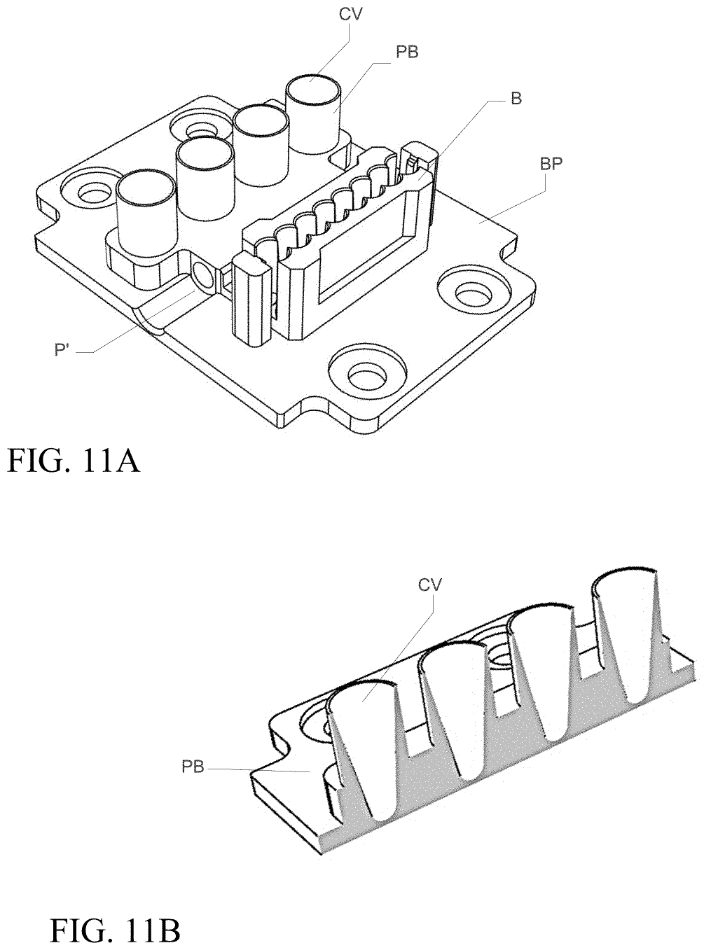

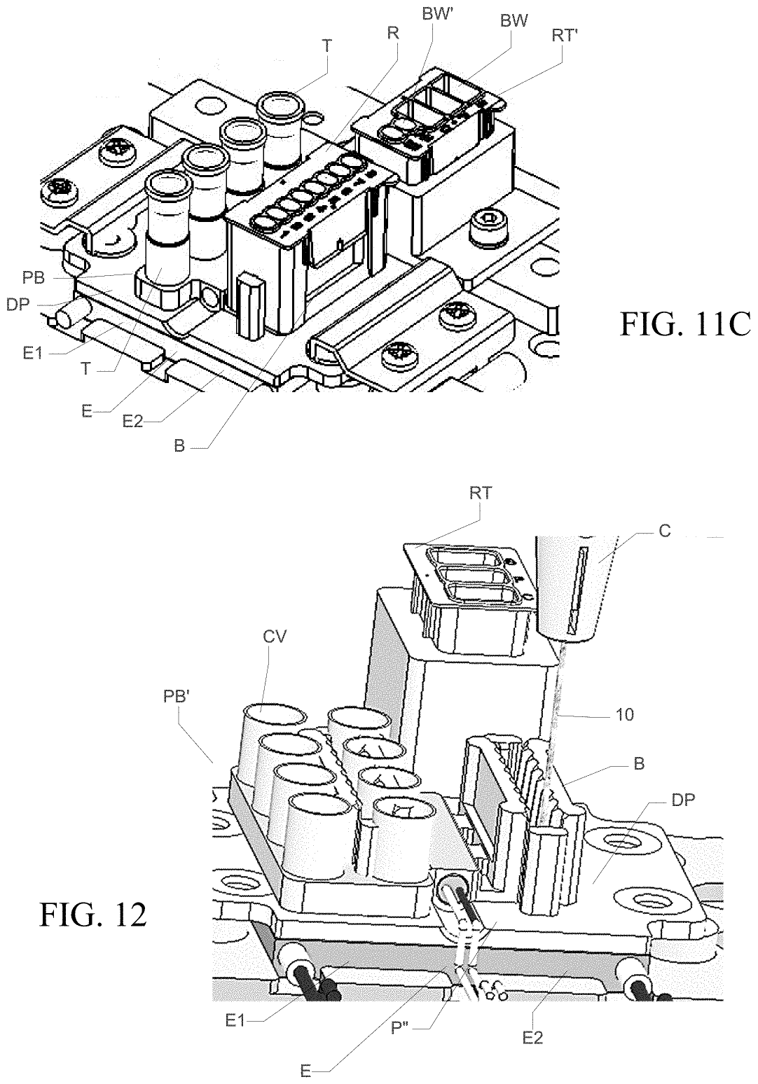

The thermal platform P has a base BP (made of a metal, e.g., aluminum) thermal conductively supporting one or more thermal blocks B (made of a metal, e.g., aluminum) for receiving and supporting one or more receptacle trays R having wells W for temperature control (i.e., heating and/or cooling operations), in accordance with one embodiment of the present invention. In the illustrated embodiment (see, e.g., FIG. 5A), two identical thermal blocks B are supported on the base BP of the thermal platform P. Two receptacle trays R are each supported by a thermal block B. See, FIGS. 11 and 12 for alternated embodiments of the thermal platforms P′ and P″. The thermal block(s) B and the supporting base BP (and other thermal block features discussed below in connection with the alternate embodiments in FIGS. 11 and 12) may be separate structures thermally conductively coupled together, or an integral, monolithic structure (e.g., machined out of a block of metal).

The temperature of each of the thermal blocks B is separately controlled by the thermoelectric module E, more specifically by the submodules E1 and E2. As will be discussed more fully below, one thermal block (e.g., on the left in FIG. 5B) may be used for heat treatments of samples (e.g., to prepare samples for PCR, as will be more fully discussed below), and the other thermal block B could be used for PCR thermocycling to obtain PCR products from samples. The submodules E1 and E2 are subject to separate controls to achieve different temperature profiles at the corresponding thermal blocks B, to thereby subject the samples in the two receptacle trays R to the different temperature profiles. The separate controls of the submodules E1 and E2 may be performed by a dedicated controller and/or the controller 26 (integrated or external). The thermal blocks B each includes a temperature sensor (e.g., a thermocouple) to feedback temperature status for controlling the temperature profiles of the corresponding submodules E1 and E2.

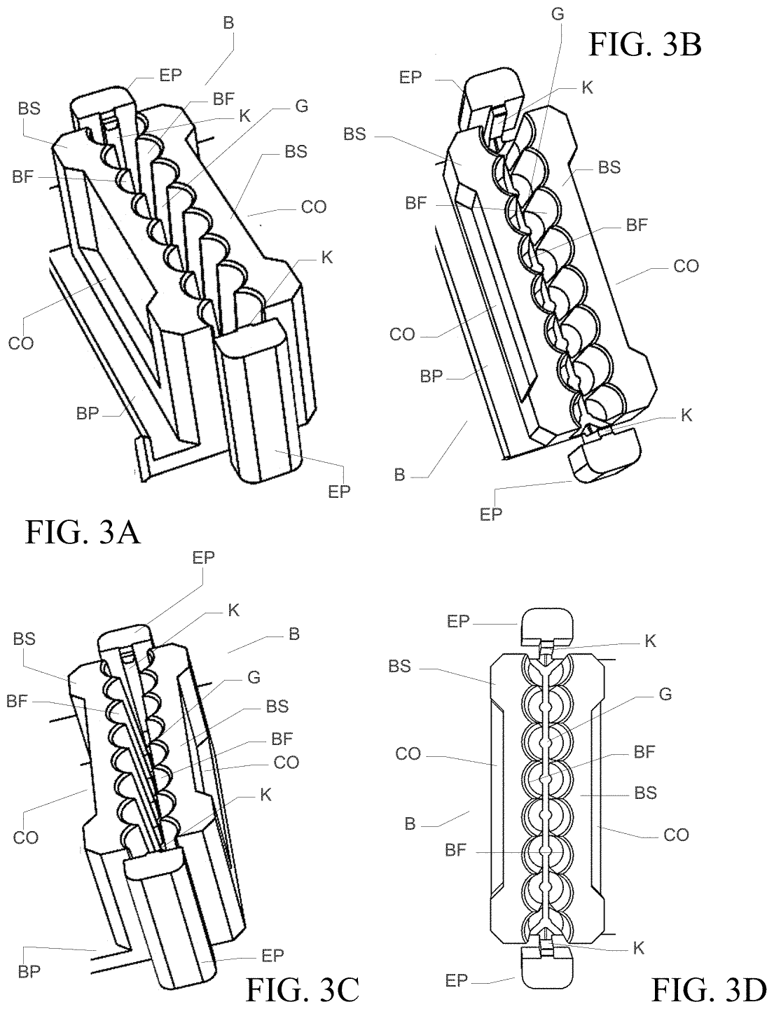

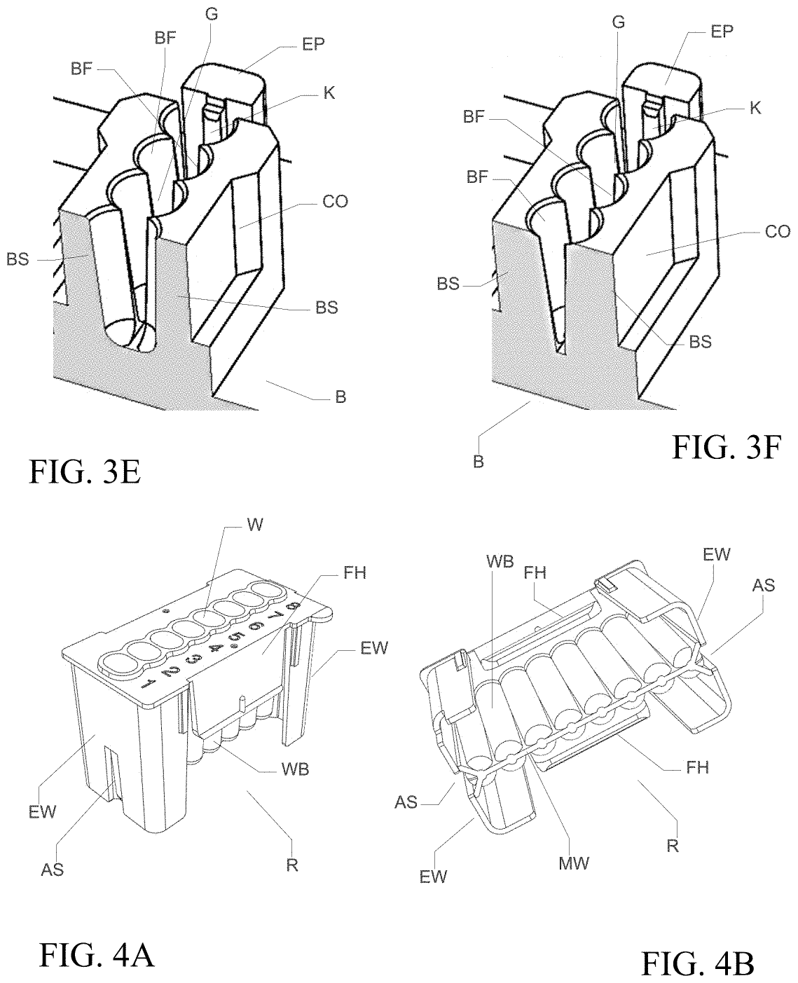

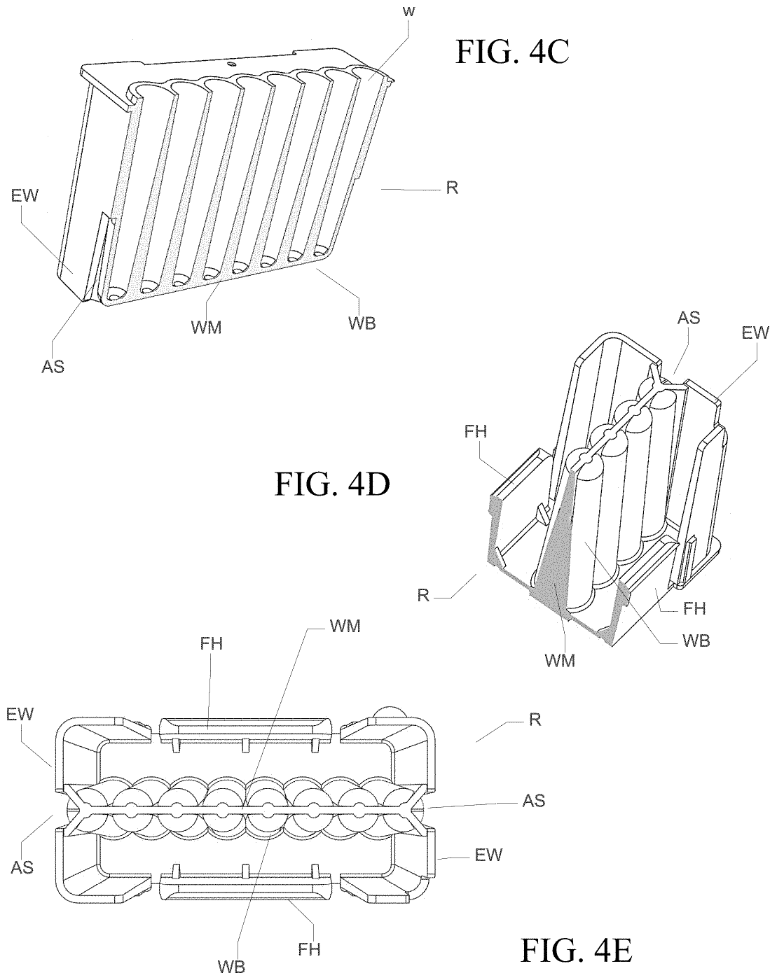

FIGS. 3A to 3C are perspective views, FIG. 3D is a top view, and FIG. 3E and 3F are sectional perspective views of the thermal block B. FIG. 4A is a top perspective view, FIG. 4B is a bottom perspective view, FIGS. 4C and 4D are sectional perspective views, and FIG. 4E is a bottom view, of a receptacle tray R that can be received and supported in the thermal block B for temperature control, in accordance with one embodiment of the present invention.

The receptacle tray R is made of a plastic material (e.g., any polymer that can be injection molded with good physical strength, uniformity and smoothness of the wells W—e.g., polyurethane, PE, PTE, PTFE, Urethane, etc.), which includes a plurality of wells W (e.g., each 2-100 ul volume) configured to hold fluidic samples. In the illustrated embodiment, the receptacle tray R includes a row of eight (8) wells W. As more clearly shown in the bottom views of FIGS. 4B and 4E, the longitudinal sectional view of FIG. 4C taken along a plane of the longitudinal mid-line of the centers of the wells W, the cross-sectional view of FIG. 4D, and the bottom view of FIG. 4E, the exterior bottom surfaces WB of adjacent wells W are joined at the mid-line sections WM of the wells W.

As illustrated, to accommodate (i.e., receive and support the wells W of the receptacle tray R), the thermal block B comprises a body that resembles a split longitudinal block having two longitudinal sides BS defining a valley, wherein the facing walls BF of the sides BS each has a scalloped concave profile conforming to the external convex conical tube shaped profile of the bottom surfaces WB of the wells W of the receptacle tray R. The thermal block B receives the receptacle tray R with the bottom external walls WB of the wells W in contact with or closely adjacent to the internal walls BF of the thermal block B to facilitate thermal conduction between the thermal block and the wells W. The facing walls BF are spaced apart by a tapered gap G to define the valley to accommodate the joined mid-line sections WM (compare similar perspective of FIG. 3F and FIG. 4D). In the illustrated embodiment, the thermal block B is shown to be substantially symmetrical about the longitudinal sectional plane through the gap G along the centers of the wells W (i.e., about the sectional plane corresponding to the sectional plane shown in FIG. 4C), and about the sectional plane transverse to such longitudinal sectional plane (i.e., about the sectional plane shown in FIG. 3F). The scalloped profile of the facing internal walls BF along with the gap G between the facing walls BF substantially conform to the profile of the exterior bottom surfaces WB of the wells W of the receptacle tray R, so as to allow efficient thermal conduction between the thermal block B and the walls of the wells W, to thereby efficiently heat/cool the contents (e.g., samples) in the wells W.

When viewed from the top of the thermal block B into the gap G, the scalloped profile generally resembles a series of adjoining concave surfaces each having a sectional profile of concave curve or arc (e.g., semicircular or partial thereof) along the internal sidewall BF of the thermal block B. In the illustrated embodiment, the internal sidewalls BF of the thermal block B define a row of cavities wherein adjacent cavities are joined/connected to accommodate the adjoining mid-line sections WM at the bottom of the receptacle tray R. The adjoining cavities resembles a row of adjoining conical spaces along the tapered gap G (narrowing/tapering to narrow the gap G towards the bottom of the block B) for receiving the conical exterior bottom surfaces WB of the wells W in the receptacle tray R.

To securely support the receptacle tray R to the thermal block B, the receptacle tray R is provided with handles FH in the form of flaps depending from the longitudinal edges of the top surface of the receptacle tray R. Complementary cutouts CO are provided on the outside wall of the sides BS of the thermal block B. Furthermore, key slots KS are provided at the end walls EW at the longitudinal ends of the receptacle tray R. Complementary end posts EP each having a vertical key K are provided outside each end of the longitudinal gap G of the thermal block B.

Referring also to FIGS. 5A to 5C which are various perspective views of the receptacle tray R supported on the thermal block B, when the receptacle tray R is seated onto the thermal block B, the wells W extend into the corresponding space defined by the scalloped walls BF, and the flap handles FH are fitted over the cutouts CO on the outside of the sides BS of the thermal block B. In this position, the sidewalls BS of the thermal block B extend upwards and tucked between the external bottom surfaces WB of the wells W and the corresponding flap handles FH. The flap handles FH resiliently grip the sidewalls BS of the thermal block B. Furthermore, the end walls EW of the receptacle tray R are fitted over the longitudinal ends of the sides BS of the thermal block B, with the keys K on the end posts EP of the thermal block B fitted into the corresponding key slots KS at the end walls EW of the receptacle tray R.

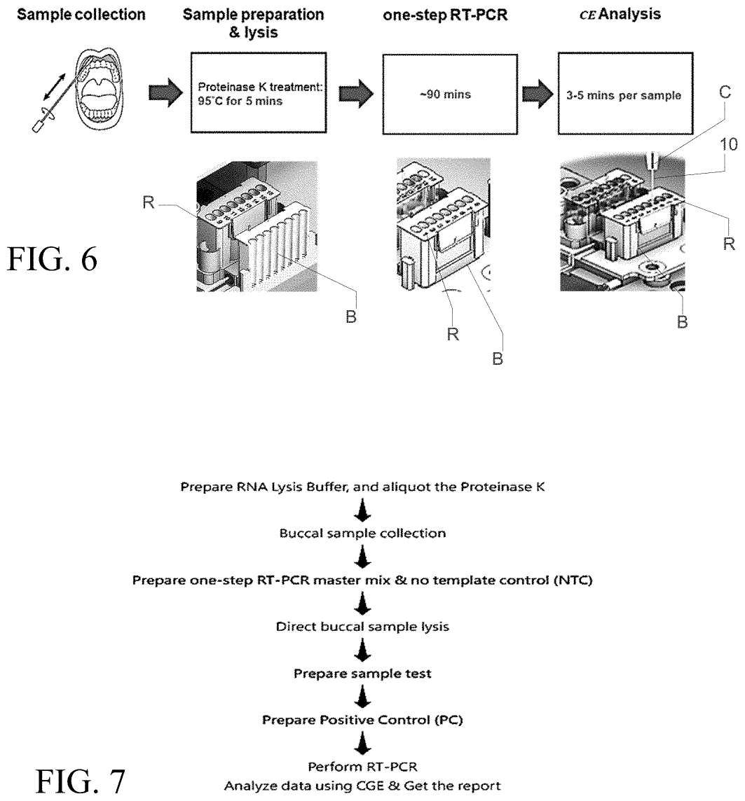

In the illustrated embodiment in FIGS. 5A to 5C, the PCR-CE instrument 100 has two thermal blocks B (compared to the embodiment of FIG. 11, which includes one thermal block B and a preheat thermal block PB), each supporting a receptacle tray R. Referring also to FIG. 6, which is a schematic diagram of a simplified PCR-CE workflow using the inventive PCR-CE system, in accordance with one embodiment of the present invention. The thermocycler TC heats (by activating the thermoelectric module E) the samples (e.g., collected from patients; 8-samples) in the wells W of the first receptacle tray R (e.g., the tray R on the block B on the left in FIG. 5B) to 95 degrees C. during sample preparation stage (e.g., Proteinase K Treatment; this can be also be performed in the four receptacle tubes T in FIG. 11). The prepared samples can then be transferred to the wells W in the second receptacle tray R (e.g., the tray R on the block B on the right in FIG. 5B) for PCR amplification processing. In the second receptacle tray R, the thermocycling (one-step RT-PCR or Reverse Transcription-Polymerase Chain Reaction) is achieved (by activating the thermoelectric module E to cycle between desired high and low temperatures), e.g., in 90 minutes, to amplify the DNA/RNA fragments, followed by direct electrokinetic injection, high voltage separation and fluorescence detection of the PCR products utilizing the pen-shaped gel-cartridge of the PCR-CE system 100. The samples (i.e., PCR products) need not be removed from the wells W of this receptacle tray R after PCR process (open PCR module with no lid/door), to be directly loaded into the capillary column 10 for follow-on electrophoresis runs. As shown in FIG. 5C, the cartridge C having the depending capillary column 10 then access the samples in the thermal block B after the PCR process, to undergo electrophoresis separation and analysis of the samples.

The above-discussed thermal control and other processes may be programmed as one or more automated functions of the controller 26.

It is noted that the inventive PCR thermocycling module TC is an open system with no lid required. The samples in the wells W in the receptacle tray R are covered with a thin layer of mineral oil to prevent evaporation and heat loss. There is no need for a separate mechanical door/lid over the PCR sample wells W with the use of mineral-oil. With such open system, one can perform CE at lower number of PCR cycles reducing the overall operating time (i.e., instead of doing 40 PCR cycles, one can perform 20 cycles at half the 90 minutes time and complete the sample injection, separation and detection using the high detection sensitivity CE approach enabled by the PCR-CE system 100 described herein).

In an alternate embodiment, if both thermal blocks B are used to perform PCR thermocycling, up to 16 samples of PCR products could be automatically analyzed using a three-axis transport mechanism TM.

### Alternate Embodiments

In accordance with another embodiment of the present invention, a preheat thermal block PB replaces one of the thermal blocks B in the previous embodiment. FIG. 11A is a perspective view a thermal platform P′ and FIG. 11B is a sectional perspective view of a thermal block in the form of a preheat thermal block PB thermal conductively supported on the base DP of the thermal platform P′. The thermoelectric module E controls the temperature of the thermal block B′ FIG. 11C is a perspective view of the thermal platform P′ supporting receptacle tubes T on the preheat thermal block PB, along with a receptacle tray R on a thermal block B similar to the previous embodiment, for PCR thermocyling. In this embodiment, preheating treatment of samples may be similar to the processes discussed above (i.e., similar to the function of the left thermal block B in FIG. 5B) but is now conducted in larger receptable tubes T in this embodiment. This could improve convenience for user to work with the larger receptable tubes T (e.g., 200 ul volume). As shown in FIG. 11B, the preheat thermal block PB has a row of four (4) conical cavities CV for receiving conical receptacle tubes T in the form of vials having conical bottoms. The main function of the receptacle tubes T is to be used for inactivating Proteinase K. After inactivation, a user needs to transfer the sample from the receptacle tubes T to the wells W of the receptacle tray R to run PCR-CE.

As was in the earlier embodiment in FIGS. 1 to 10, the temperature of each of the preheat thermal block PB and thermal block B is separately controlled by the thermoelectric module E, more specifically by the submodules E1 and E2 that are subject to separate controls to achieve different temperature profiles. In this embodiment, the temperature profile of the preheat thermal block PB is controlled by the submodule E1 for heat treatments of samples (e.g., heating and subsequent cooling) to prepare samples for PCR, and the temperature profile of the thermal block B is controlled by the submodule E2 for PCR thermocycling (e.g., undergoing a plurality of temperature cycles) to obtain PCR products from samples. As was in the previous embodiment, The preheat thermal block PB and the thermal block B each includes a temperature sensor (e.g., a thermocouple) to feedback temperature status for controlling the temperature profiles of the corresponding submodules E1 and E2.

Further in this embodiment, the reagent tray RT′ is provided with two additional smaller wells BW′ for additional reagents that might be need for certain CE protocols, e.g., alignment marker (AM) and size marker (SM).

In a further embodiment, the preheat thermal block PB is replaced with a different thermal block PB′ having more cavities. FIG. 12 is a perspective view of another thermal platform P″, in accordance with a further embodiment of the present invention. In this embodiment, the thermal block PB′ has two (2) rows of four (4) cavities (similar to the cavities CV in FIG. 11) for receiving similar conical receptacle tubes T (or vials) for preheat and cooling treatments of samples. As shown in FIG. 12, the thermal platform P″ includes a similar thermal block B as in the previous embodiments.

As were in the earlier embodiments, the temperature of each of the preheat thermal block PB′ and thermal block B is separately controlled by the thermoelectric module E, more specifically by the submodules E1 and E2 that are subject to separate controls to achieve different temperature profiles.

### APPLICATIONS

Most of the standard viral detection methods around the world are using real-time PCR (qPCR). However, the operation and interpretation of real-time PCR test results require professional or well-trained technicians and false-positive results are often occurring. The Assignee of the present invention has developed a total solution, which includes Direct “RT-PCR” (using pre-programmed chip for 8-samples run) integrated with the portable PCR-CE system 100 to solve the problems associated with traditional real-time PCR systems. Furthermore, the PCR-CE detection platform in the PCR-CE system 100 utilizes appropriate Direct “RT-PCR” reagents, which eliminates the need for nucleic acid extraction and purification, where it provides a unique solution for rapid pathogen detection with reproducible results by nontechnical operators. In addition, it resolves the false positive issues associated with real-time PCR systems, since the inventive PCR-CE system 100 platform has much higher detection sensitivity and provides better detection capabilities for early stages of the infected patient screening (i.e., field pathogen detection). Furthermore, the inventive platform should be suitable as a reconfirm platform after real-time PCR increasing the reliability of the diagnosis of the disease more efficiently.

By mixing the swab with our lysis buffer and transfer of 2 micro liter of the lysed sample directly onto the PCR-CE system 100, such system performing the tests automatically.

### Example: PCR-CE system for SARS-CoV-2 Detection

As an example, the compact detection platform in the PCR-CE system 100 can provide fast, accurate and cost-effective results which should be suitable for decentralized testing application of COVID-19.

BiOptic Inc., the Assignee of the present invention, developed the Qexp-MDx Direct SARS-CoV-2 Detection Kit-B, that includes the assays and positive control for the direct multiplex one-step reverse transcription PCR (RT-PCR) testing for the qualitative detection of RNA from SARS-CoV-2 in buccal specimens from individuals suspected of COVID-19 by healthcare provider. The results are for the identification of SARS-CoV-2 RNA, which is generally detectable in the oral specimen during the acute phase of infection. Positive results are indicative of the presence of SARS-CoV-2 RNA. Clinical correlation with patient history and other diagnostic information is necessary to determine patient infection status. Positive results do not rule out a bacterial infection or co-infection with other viruses. The agent detected may not be the definite cause of the disease. Laboratories within US, Europe, Asia and its territories are required to report all positive results to the appropriate public health authorities. And Negative results do not preclude SARS-CoV-2 infection and should not be used as the sole basis for patient management decisions. Negative results must be combined with clinical observations, patient history and epidemiological information.

The BiOptic Qexp-MDx Direct SARS-CoV-2 Detection Kit-B includes the following components:
a. Direct Lysis assay Sample lysis assay contains Collection Buffer, Proteinase K, RNase Inhibitor, and RNA Lysis Buffer.
b. Direct SARS-CoV-2 Kit assay Direct SARS-CoV-2 multiplex one-step RT-PCR assay: the multiplexed assays contain a primer set specific to the Envelope region (E=129 bp) of the SARS-CoV-2 genome. Also, a primer set for internal control specific to the human RNase P (170 bp) gene.
c. Direct SARS-CoV-2 Kit Positive Control: the main component of positive control is synthetic RNA containing the target region of SARS-CoV-2 and the human RNase P.

The RNA from buccal specimens could be released by using the required RNA Lysis Buffer. The RNA from buccal sample lysate is reverse transcribed into cDNA and amplified by the multiplex one-step RT-PCR on PCR thermal cycler. In the process, the primers anneal to a specific gene of SARS-CoV-2 and a human internal control as follows: E (envelope) protein and Human RNase P.

FIG. 7 is a schematic diagram of a PCR-CE workflow for buccal specimens using the inventive automated system, in accordance with one embodiment of the present invention.

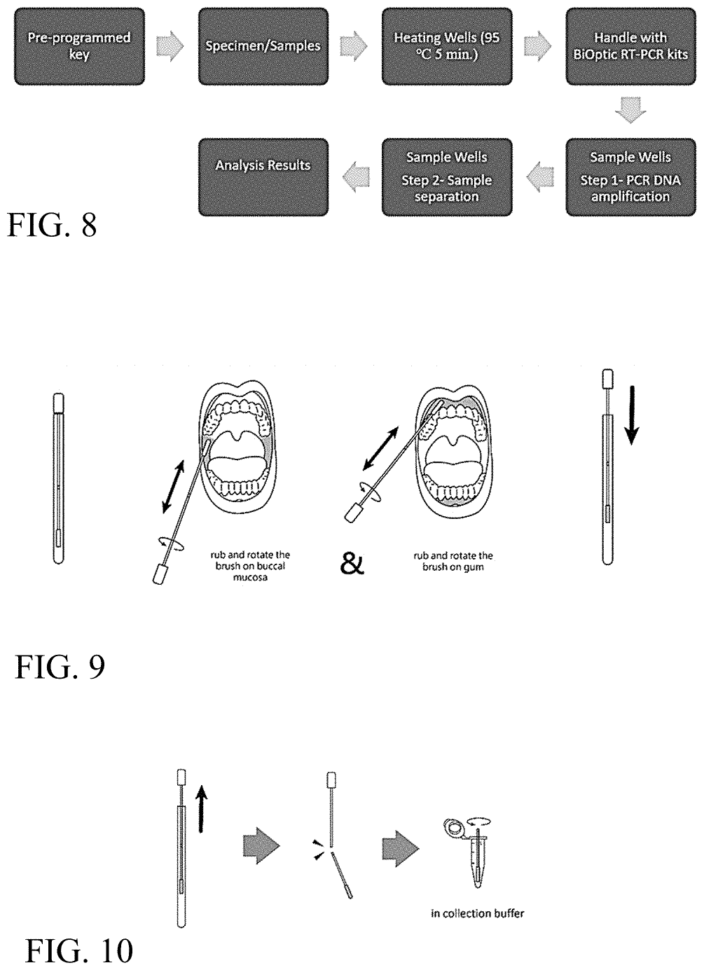

FIG. 8 is a block diagram of the complete steps for introducing samples into the PCR-CE instrument, prepare samples by heating and proceed to RT-PCR and end-point PCR through CE analysis.

### Direct Buccal Sample Lysis & Proteinase K treatment

FIG. 9 is a schematic diagram of a buccal sample collection procedure, in accordance with one embodiment of the present invention. FIG. 10 is a schematic diagram of a sample preparation process for buccal sample, in accordance with one embodiment of the present invention.

Once the buccal sample lysate has been prepared 20 μL of the buccal mixture (RNA Lysis Buffer) is transferred into a clean receptacle (e.g., a well W in a receptacle tray R on the left in the embodiment of FIG. 5B, or a receptacle tube T in FIG. 11C) and then heated to 95° C. for 5 mins to inactivate Proteinase K, then cooled down to 4° C. by the thermal control module TC. The PCR-CE instrument is equipped with 8-sample capacity receptacle tray R for thermocycling (PCR) stage (see, e.g., FIGS. 5B and FIG. 11C).

### Exemplary Thermal Cycling Operation

In the illustrated embodiment, the built-in thermocycler module TC (Peltier based heater and cooler) in the PCR-CE instrument 100 is equipped with 8-well samples tray (receptacle tray R of FIG. 5C or FIG. 11C) to perform the Direct SARS-CoV-2 multiplex one-step RT-PCR step. Pre-defined PCR protocol(s) can be pre-programmed or stored in, e.g., a USB memory key or SD memory card, which is inserted into the USB port DU or the SD card slot SL in the instrument housing to perform the programmed tests (FIG. 1A). The table below shows the PCR cycles pre-programmed, e.g., in a USB memory key or SD memory card, for the operation of thermocycler. In one embodiment, in the table below, a memory card can be pre-programmed to include the number of cycles for each step specific to applications of MDx, as an example.

| | Number of | Temperature | | |
|---|---|---|---|---|
| Step | cycles | (° C.) | Time | |
| Reverse transcription | 1 | 50 | 15 | minutes |
| Activation | 1 | 95 | 10 | minutes |
| Denaturation | 44 | 95 | 15 | seconds |
| Anneal | | 60 | 20 | seconds |
| Extension | | 72 | 20 | seconds |
| Extension | 1 | 72 | 5 | minutes |

| | | |
|---|---|---|
| 1 | 4 | hold |

The post-PCR samples are then analyzed by the PCR-CE system 100. Once the RT-PCR step is complete, the PCR products are automatically injected into the capillary gel-cartridge and analyzed individually by the automated PCR-CE system (e.g., FIG. 5A). The results are then analyzed by a data analysis software, and a report is generated displaying the size of target sequences (retention time) or by calling out the peaks (RNaseP and E gene). The test results may be displayed in electropherogram and gel image format by the data analysis software.

In summary, the PCR-CE platform of the present invention utilizes Direct “RT-PCR” reagents, which eliminates the need for nucleic acid extraction, where it provides a unique solution for rapid pathogen detection with high sensitivity and reproducible results by nontechnical operators. In addition, it resolves the false positive issues associated with conventional real-time PCR systems, since the platform has much higher sensitivity and provides better detection capabilities. Furthermore, the inventive platform should be suitable as a reconfirm platform after real-time PCR increasing the reliability of the diagnosis of the disease more efficiently. The advantages include:
a. Direct RT-PCR amplification. There is no need for RNA extractions and purifications. Buccal or nasal swabs are immersed into a lysis buffer that liberates the nucleic acids. The RNA in these lysates can then be used to set up the Reverse Transcriptase PCR Amplifications.
b. Reverse Transcriptase PCR Amplifications are run on the PCR-CE System. There is no need for costly Real-Time PCR instruments.
c. PCR products that have been generated after the full number of cycles are then analyzed by the fully automated Capillary Gel Electrophoresis (CGE) platform (PCR-CE system 100) utilizing re-usable pen shaped gel-cartridges. Results for up to 8 samples can be obtained quickly.

While the invention has been particularly shown and described with reference to the preferred embodiments, it will be understood by those skilled in the art that various changes in form and detail may be made without departing from the spirit, scope, and teaching of the invention.

We Claim:

1. A thermal control module for a bioseparation system, comprising:
a thermal platform thermally coupled to the thermoelectric module, wherein the thermal platform comprises:
a base, and
at least a thermal block thermal conductively supported on the base, wherein the thermal block is structured to receive a receptacle containing at least a sample, and wherein the thermal block comprises a body comprising a split longitudinal block having two longitudinal sides defining a valley, wherein the facing walls of the sides each has a scalloped concave profile conforming to convex conical tube shaped profile of bottom surfaces of the wells of the receptacle tray;
a heat sink; and
a thermoelectric module thermal conductively coupled between the base of the thermal platform and the heat sink, heating/cooling the thermal platform in accordance with desired heating/cooling temperature profile.
